(19) United States
(12) Patent Application Publication
(10) Pub. No.: US 2003/0177312 A1
(43) Pub. Date: Sep. 18, 2003

(54) Controlling a store data forwarding mechanism during execution of a load operation

(76) Inventors: Aravindh Baktha, Portland, OR (US); Michael D. Upton, Portland, OR (US); Thomas R. Huff, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/099,519

(22) Filed: Mar. 15, 2002

(51) Int. Cl. G06F 12/00

(52) U.S. Cl. 711/118; 711/168

(57) ABSTRACT

In an out-of-order execution computer system, a fast store forwarding buffer (FSFB) is conditionally signaled to output buffered store data of buffered memory store instructions to fill a buffered memory load instruction. The FSFB is coupled to a rotator so that the store data can be rotated from a first position to a second position. A control unit coupled with the FSFB determines whether or not to signal the FSFB to forward the store data. The control unit is also coupled with the rotator to signal the rotator whether and by how much to rotate the forwarded store data. The control unit is configured to detect a number of dependencies between a buffered memory load instruction and one or more buffered memory store instructions.

### FIELD

The invention relates to processors and, more particularly relates to forwarding buffered store data on an out-of-order execution processor.

### BACKGROUND

A computer system may be divided into three blocks: one or more processors, a memory hierarchy, and one or more input/output (I/O) units. These blocks are coupled to each other by one or more buses. An input device, such as a keyboard, mouse, stylus, etc., is used to input data into the computer system through an I/O unit. The inputted data can be stored in memory. The processor receives the data stored in memory and processes the data as directed by a set of instructions. The results can be stored back into the memory hierarchy or outputted through the I/O unit to an output device such as a printer, cathode-ray tube (CRT) display, etc.

Some processors have the capability to execute instructions out-of-order. Generally, out-of-order execution is possible when the instructions being executed out-of-order are not dependent on one another. A subsequently issued instruction is not dependent on a previously issued instruction if the subsequently issued instruction does not rely on the previously issued instruction for its resulting data or its implemented result.

The processor may also be capable of executing instructions speculatively. Speculative execution of instructions requires a processor to make a predication about the result of a conditional branch before the result of the conditional branch is known for certain. The processor may fetch and issue instructions based on its prediction of the outcome of a conditional branch. For a detailed explanation of speculative out-of-order execution, see, for example, M. Johnson, Superscalar Microprocessor Design, Prentice Hall, 1991.

The processor receives data from memory as a result of performing load operations. Each load operation is typically initiated in response to a load instruction (LD). The LD specifies an address of the location in memory at which the desired data is stored (hereinafter, LD address). The load instruction also specifies the amount of data that is desired (hereinafter, LD data request). Generally, the LD address specifies where the first byte of data requested by the LD resides. Any additional data requested by the LD is stored in memory locations with addresses that follow sequentially from the LD address. Using the LD address and the LD data request, the memory hierarchy may be accessed and the desired data obtained.

The processor stores data into memory as a result of performing store operations. Each store operation is typically initiated in response to a store instruction (ST). The ST specifies an address of the location in memory in which data is to be stored (hereinafter, ST address). STs also include a ST data block comprising the data to be stored in memory. Generally, the ST address specifies where the first byte of data of the ST data block is to be stored. Any additional bytes of data in the ST data block are stored in memory locations with addresses that follow sequentially from the ST address. Some systems divide a ST into store address and store data instructions. For the purposes of this application, a ST includes both the store address and the ST data block.

Special considerations exist with respect to performing memory operations out-of-order in a computer system. Memory operations are ordered to ensure that the correct data is being transferred. For example, if a ST and a LD have the same destination and source addresses respectively, and the ST precedes the LD in the instruction stream, then the store operation must occur before the load operation to ensure that the correct data will be subsequently loaded. If the load operation is allowed to be completed before the store operation, then the data loaded would more than likely not be the data that the store operation would have stored in the memory location.

### BRIEF DESCRIPTION OF THE DRAWINGS

The invention is illustrated by way of example, and not by way of limitation, in the figures of the accompanying drawings in which like reference numerals refer to similar elements.

FIG. 1 illustrates an electronic system.

FIG. 2 illustrates one embodiment of portions of the processor shown in FIG. 1 in greater detail.

FIG. 3 illustrates one embodiment of portions of the execution unit and the memory order buffer shown in FIG. 2 in greater detail.

FIG. 4 illustrates one embodiment of portions of the FSFB shown in FIG. 3.

FIG. 5 illustrates one embodiment of portions of the load buffer shown in FIG. 3.

FIG. 6 shows a block diagram of one embodiment of the conceptual relationships between the FSFB, memory order buffer, rotator, and register file.

FIG. 7 is a block diagram of a ST with a ST address misaligned to a LD address that fills the LD data request.

FIG. 8 is a block diagram of one embodiment of the FSFB being prevented from filling a LD with store data from a ST that has a complete address that is only a partial match to the complete address of the LD.

FIG. 9 is a block diagram illustrating an embodiment to prevent data from being forwarded if a complete ST address does not match a complete LD address and also forwards store data from a ST that has a complete address that matches the complete LD address.

FIG. 10 is a flow diagram illustrating a ST misaligned to a LD used to forward data to fill the LD.

FIG. 11 is a flow diagram of a quad-word of data within a ST data block to be forwarded to a misaligned LD.

FIG. 12 is a flow diagram of a technique to distinguish between a ST with a ST address that partially matches a complete LD address from a ST with a complete ST address that matches the complete LD address.

### DETAILED DESCRIPTION

Embodiments of systems and methods for detecting dependencies between buffered load instructions (LDs) and buffered store instructions (STs) are described in detail herein. Also, embodiments of systems and methods to forward buffered ST data to satisfy a buffered LD based upon certain detected dependencies are described herein. In the following description, numerous specific details are provided in order to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Some computer systems use a fast store forwarding buffer (FSFB) to fill LDs from STs that have not yet been written into memory. A FSFB has buffer slots to buffer STs within the execution core of the processor. The FSFB can be configured to forward Store data from a ST data block to a register file of the processor before the ST data block is written into cache memory. In order to forward store data to fill a LD, the processor must be able to determine whether the FSFB contains the data requested by the LD. In other words, the processor must be able to determine whether the LD is dependent on a ST buffered in the FSFB before the required data can be forwarded to the register file. Previous FSFBs have been able to detect dependencies between a LD and a buffered ST only when the LD address matches the ST address.

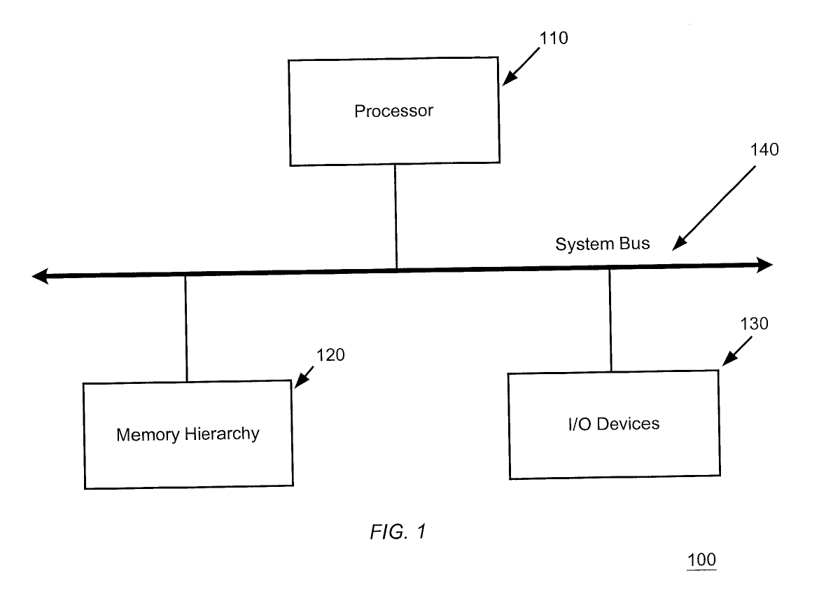

FIG. 1 is a block diagram of one embodiment of an electronic system 100. System 100 includes a processor 110, a memory hierarchy unit 120, I/O device(s) 130, and a system bus 140 coupled to each other. In one embodiment, system 100 supports virtual address spaces including memory locations of the memory hierarchy unit 120 and the addresses of the I/O devices 130, which are partitioned into memory pages and organized into memory segments. During program execution, processor 110 buffers STs and forwards buffered store data to fill LDs if appropriate.

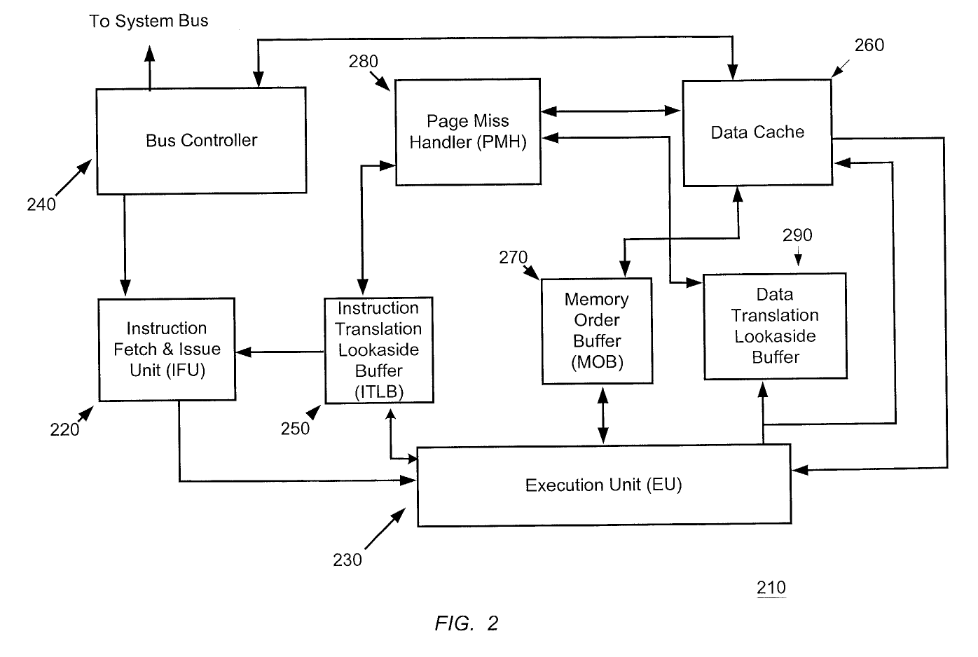

FIG. 2 is a block diagram of one embodiment of processor 110 from FIG. 1. Processor 110 includes instruction fetch unit (IFU) 220, execution unit (EU) 230, bus controller (240), instruction translation lookaside buffer (ITLB) 250, data translation lookaside buffer (DTLB) 290, page miss handler (PMH) 280, memory order buffer (MOB) 270, and data cache (DC) 260. Together elements 220-290 operate to fetch, issue, execute, and save execution results of instructions in a pipelined manner. Additional and/or different elements can also be included in processor 110.

IFU 220 fetches instructions from memory hierarchy unit 120 through bus controller 240 and the system bus 140. Some instructions are fetched and issued speculatively. EU 230 executes the instructions when operand dependencies are resolved. In other words, the instructions are not necessarily executed in the order they are issued, and some instructions are speculatively executed. The execution results, however, are retired or committed in order, and speculative results of mispredicted branches are purged.

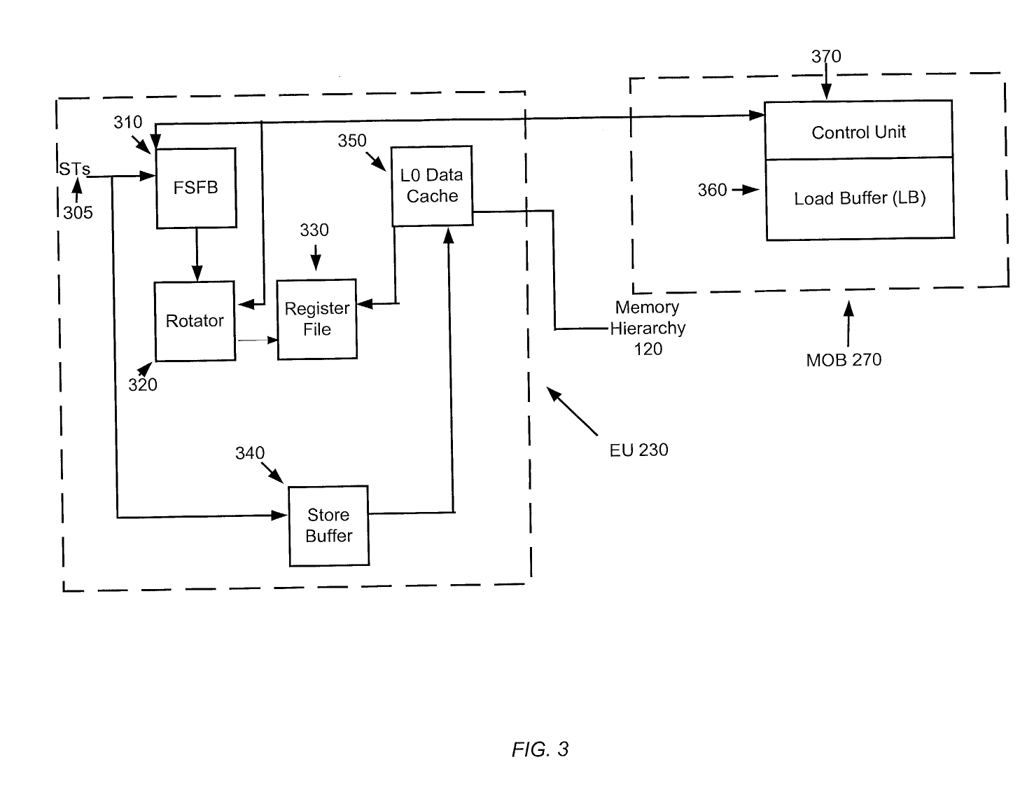

FIG. 3 is a block diagram of one embodiment of EU 230 and MOB 270. EU 230 includes fast store forwarding buffer (FSFB) 310, rotator 320, register file (RF) 330, store buffer (SB) 340, and L0 data cache 350. FSFB 310 receives STs from functional units of the EU (not shown) and is coupled with rotator 320 and control unit 370. Rotator 320 is coupled with MOB 270 and RF 330. Rotator 320 receives store data from FSFB 310 and rotates the store data until the store data is in a desired order. Rotator 320 forwards the rotated store data to RF 330. Store buffer (SB) 340 receives STs 305 and is coupled with L0 data cache 350. L0 data cache 350 is coupled with SB 340, RF 330, and memory hierarchy unit 120.

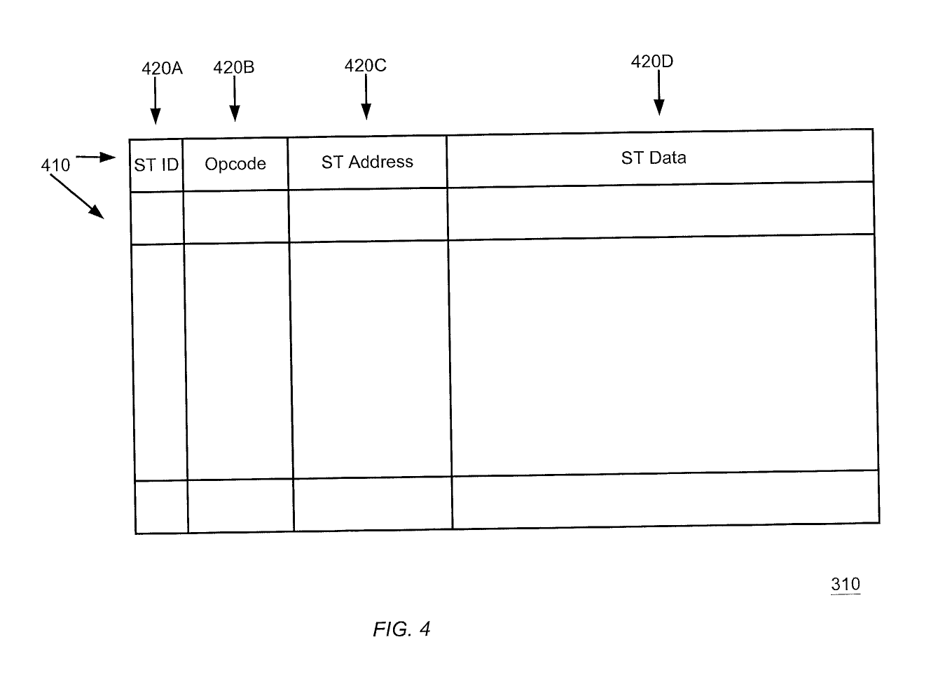

FIG. 4 illustrates one embodiment of a FSFB. FSFB 310 includes buffer slots 410. FSFB buffer slots 410 include store identification number 420A, store opcode 420B, store address 420C, and store data 420D. Each ST is allocated a buffer slot 410 in FSFB 310. FSFB 310 is employed to forward store data 420D to RF 330 (through rotator 320). L0 data cache 350 also provides store data to RF 330. FSFB 310 forwards store data to RF 330 more quickly than L0 data cache 350. The performance of processor 110 is enhanced to the extent store data is forwarded from FSFB 310 rather than L0 data cache 350. FSFB 310 may comprise buffer slots 410 that include fields other than the fields described herein. For example, in alternative embodiments, buffer slots 410 may include a field for a number of control and state bits and may not contain an opcode field.

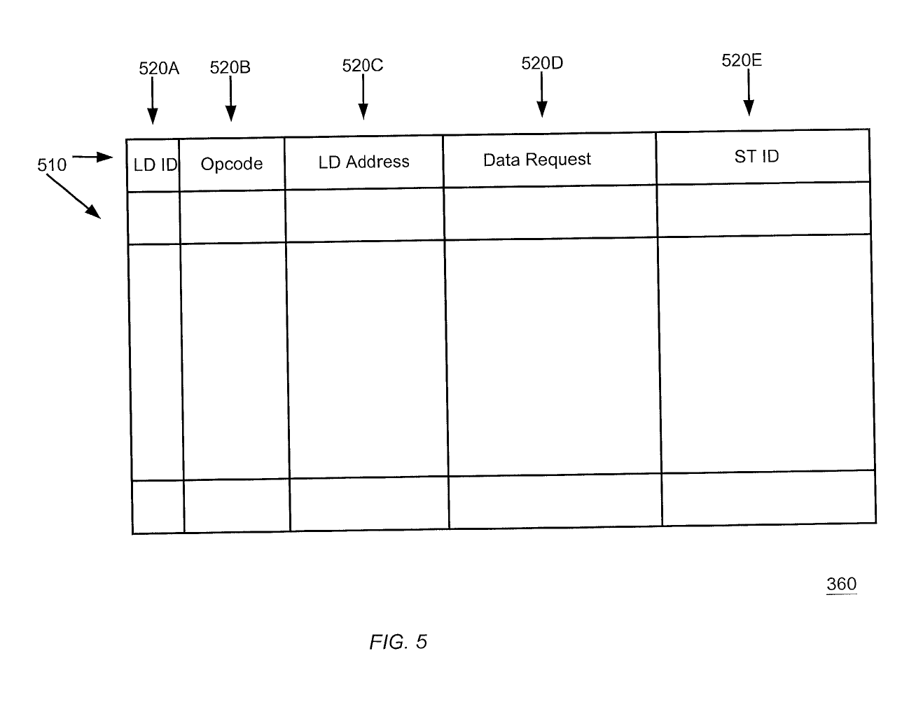

MOB 270 includes control unit 370 and load buffer (LB) 360. In one embodiment, LB 360 includes LB buffer slots 510 as shown in FIG. 5. LB buffer slots 510 comprise LD ID 520A, opcode 520B, LD address 520C, data request 520D, and ST ID 520E. In one embodiment, each LD is allocated a buffer slot in LB 360 of MOB 270. ST ID 520E is used to identify which buffered STs are older than the buffered LD. The relative age of the buffered LD and buffered STs may be determined in a variety of manners including but not limited to time stamping the various LDs and STs.

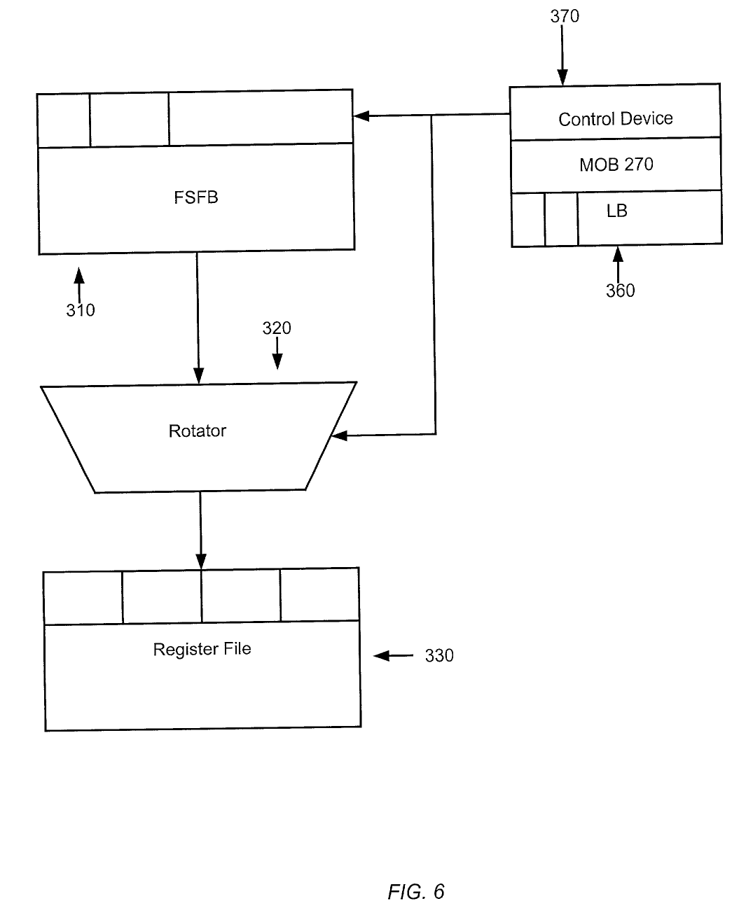

FIG. 6 is a block diagram illustrating MOB 270, FSFB 310, rotator 320, and RF 330. As will be more fully described below, control device 370 is configured to detect certain dependencies between a LD buffered in LB 360 and any of the STs buffered in FSFB 310. Prior art processors are configured to forward buffered store data from FSFB 310 to RF 330 if a buffered ST has a ST address that is aligned to the LD address. The performance of processor 110 is enhanced to the extent LD data requests can be filled by store data forwarded from the FSFB, which is not supported in the prior art.

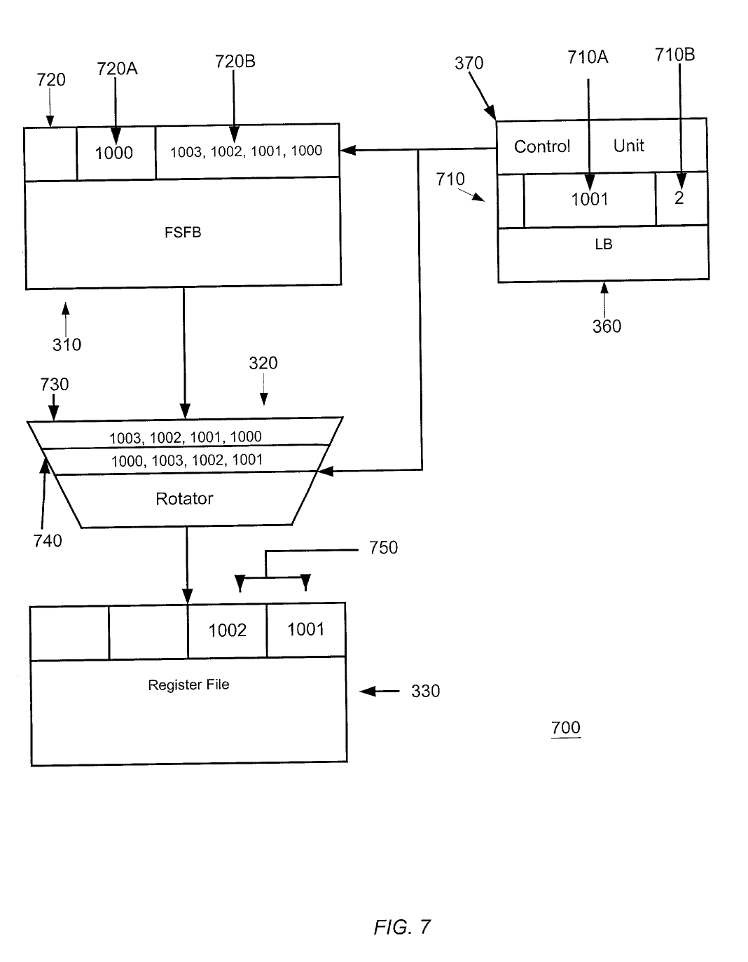

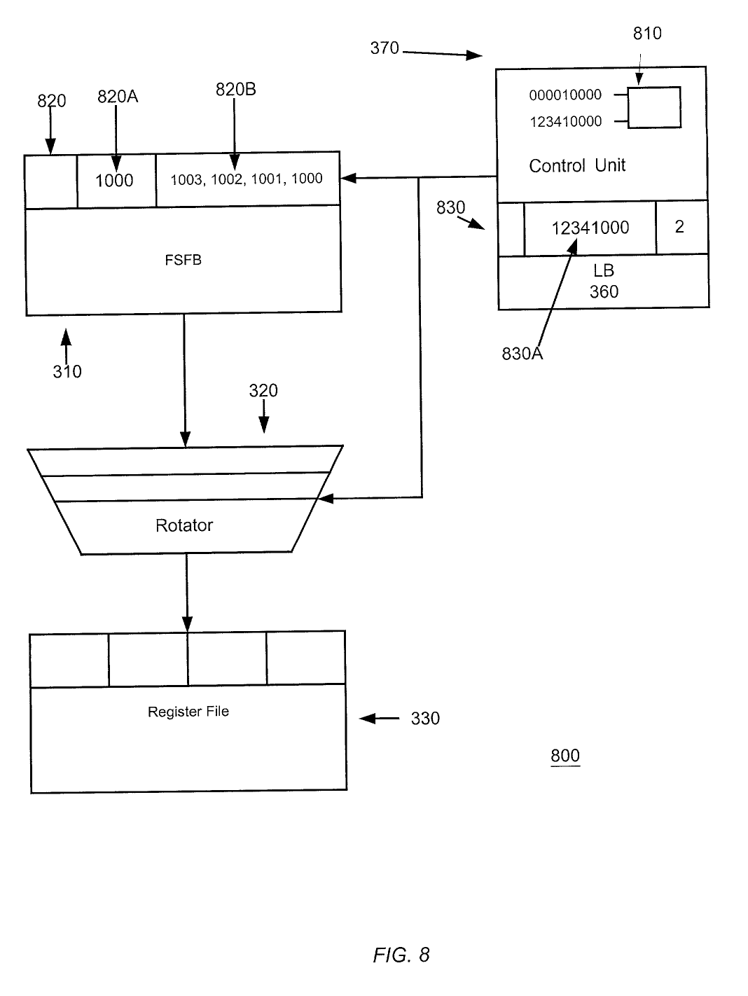

FIG. 7 illustrates an example block diagram of system 700. System 700 includes FSFB 310, rotator 320, RF 330, LB 360, and control unit 370. Buffered LD 710 includes LD address 710A and data request 710B. Buffered LD 710 requests two bytes of data starting from main system memory address 1001. Buffered ST 720 includes ST address 720A and ST data block 720B. Buffered ST 720 contains four consecutive bytes of store data starting with main system memory address 1000. LD address 710A and ST address 720A are not aligned with each other. Therefore, prior art processors cannot forward ST data block 720B to fill LD 710.

Control unit 370 detects misaligned dependencies like the one that exists between LD 710 and ST 720. Control unit 710 directs FSFB 310 to forward ST data block 720B. ST data block 720B is forwarded to rotator 320 at 730. Rotator 330 is intended to represent a broad range of rotators, shift registers, barrel shifters, and other devices that can reorder data. Control device 370 directs rotator 320 to rotate data within ST block 720B at 740. In one embodiment, rotator 320 forwards two bytes of store data to RF 330 at 750. In alternate embodiments, a different number of bytes of the store data can be forwarded. Thus, system 700 detects dependencies between misaligned buffered LDs and buffered STs. System 700 also rotates data within a ST data block so that the ST data block is aligned to the LD address. Therefore, system 700 fills a buffered LD with store data for a ST that has a misaligned ST address relative to the LD address.

FIG. 8 illustrates an embodiment of a system to prevent store data from being forwarded when there is only a partial match between a complete LD address and a complete ST address. In order to execute instructions more quickly, EU 230 uses only a portion of a main system memory address to identify a memory location. In one embodiment, system 800 uses the first 16 bits of each 32 bit linear address to identify the main system memory address corresponding to ST 820.

References to ST addresses and LD addresses refer to the partial addresses used by EU 230 and references to complete LD addresses and complete ST addresses refer to the full main system memory addresses used by MOB 270. MOB 270 stores complete addresses for buffered LDs and buffered STs. Thus, prior art systems might forward data based on a match between a LD address and a ST address that is later discovered to be a false match by MOB 270. Prior art systems do not provide a direct mechanism for MOB 270 to correct cases where FSFB 310 forwards store data based on a false match. Instead, prior art processors use the memory hierarchy unit (i.e., data cache) to correct cases where FSFB 310 has forwarded Store data based on a false match.

Control unit 370 of FIG. 8 detects and corrects cases where FSFB 310 attempts to forward data based on a false match between a LD address and a ST address. In one embodiment, control unit 370 includes comparator 810. Buffered ST 820 comprises a 32-bit ST address for which the first 16 bits are shown at 820A. Buffered LD 830 comprises a 32 bit LD address 830A. Comparator 810 compares the complete address of buffered LD 830 with the complete address of a buffered ST 820. Control unit 370 uses comparator 810 to detect whether bits [15:0] of 820A match bits [15:0] of 830A and also whether bits [31:16] of 820A and match bits [31:16] or 830A. Control unit 370 can be configured in a number of different ways to determine whether FSFB 310 is attempting to forward Store data based on a false match. If control unit 370 detects that FSFB 310 is attempting to forward Store data based on a false match between a LD address and a ST address, it directs FSFB 310 to not forward the Store data of the ST that has generated the false match.

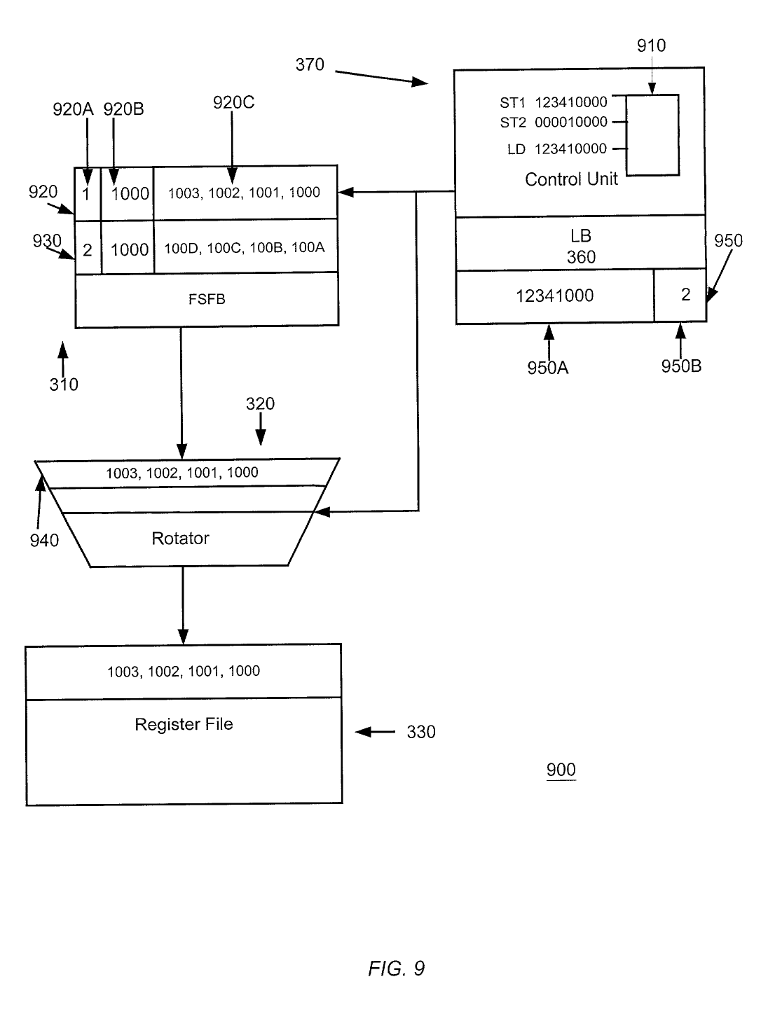

FIG. 9 illustrates an embodiment that detects when more than one buffered ST has a ST address that matches the LD address. LB 360 comprises LD 950 having LD address 950A and LD data request 950B. Reference numerals 950A and 950B illustrate that LD 950 requests two bytes of data starting with the data stored in main system memory address 12341000. FSFB 310 comprises ST 920 and ST 930. ST 920 and ST 930 each include a ST ID 920A, a ST address 920B, and a ST data block 920C. ST 930's larger ST ID number indicates that ST 930 issued later in time than ST 920.

According to the prior art, FSFB 310 determines that ST 930 and ST 920 both have ST addresses that match LD 950's LD address. Also, according to the prior art, FSFB 310 will select ST 930's data block to forward to RF 330 because ST 930 issued more recently than ST 920. Control unit 370, however, detects that ST 930's complete address does not match LD 950's complete address. Control unit 370 also detects that ST 920 does have a complete address that matches LD 950's complete address. According to one embodiment, control unit 370 informs FSFB 310 that ST 930 cannot fill LD 950 and further directs FSFB 310 to forward ST 920's data block to RF 330 to fill LD 950.

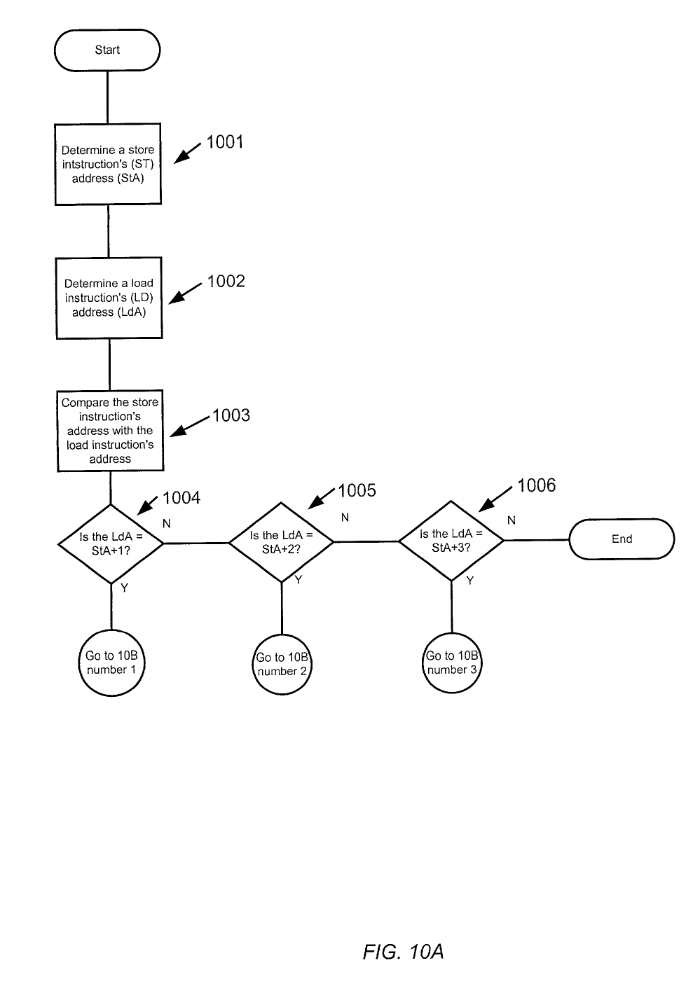

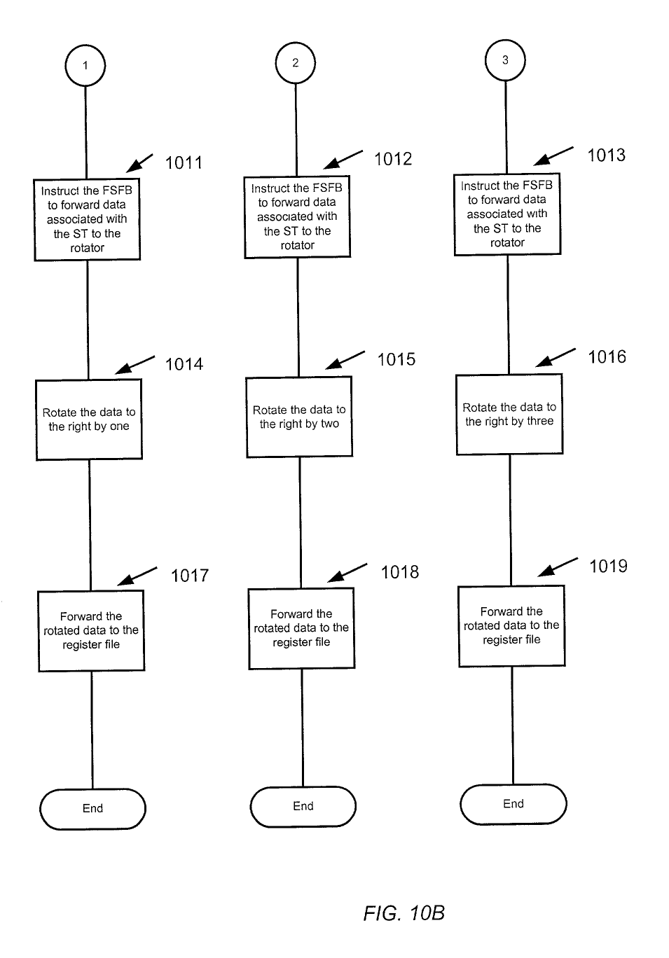

FIGS. 10A and 10B are flow diagrams illustrating one embodiment of fast forwarding of ST data. In process block 1001, control unit 370 determines a ST address of a selected buffered ST. Similarly, control unit 370 determines a LD address of a selected buffered LD in 1002. Control unit 370 compares the ST address with the LD address in process block 1003 to determine whether the LD address is misaligned with the ST address. In decision blocks 1004-1006, control unit 370 determines whether the LD address is misaligned by one, two, or three bytes respectively.

In process blocks 1011-1013, control unit 370 directs FSFB 310 to forward a ST data block from the buffered ST with an address misaligned by one, two, or three bytes from the LD address of the buffered LD. In process blocks 1014-1016, control unit 370 directs the rotator to rotate the data within the data block by the number of bytes that is equal to the misalignment between the LD address and the ST address. Control unit 370 forwards the rotated Store data to RF 330 in process blocks 1017-1019.

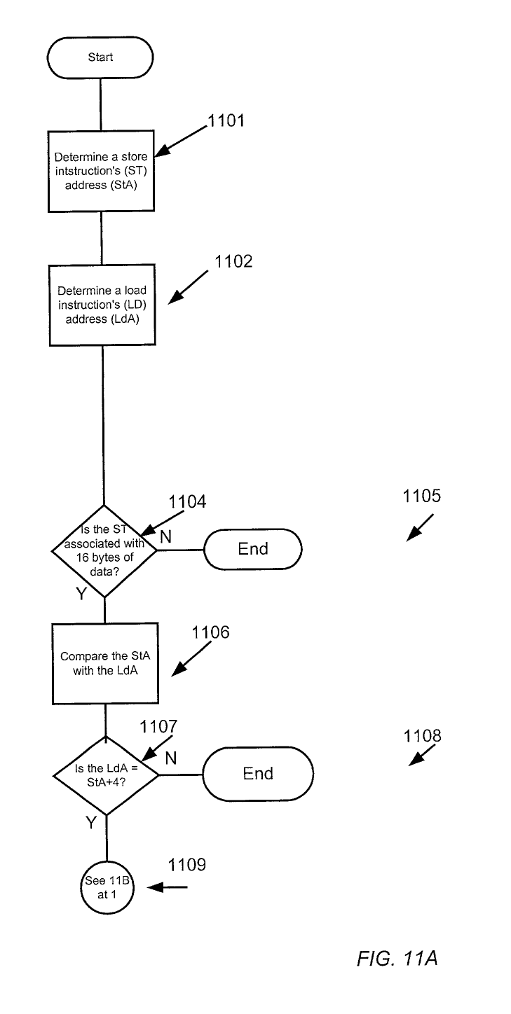

FIGS. 11A and 11B are flow diagrams illustrating another embodiment of a fast forwarding technique. In process block 1101, control unit 370 determines a ST address of a selected buffered ST. Control unit 370 determines a LD address of a selected buffered LD at 1102. According to one embodiment, in decision block 1104, control unit 370 determines whether the selected buffered ST contains 16 bytes of store data in its ST data block. In alternative embodiments, the number of bytes of store data may be more or less. If the selected ST does not include a 16-byte data block, then control unit 370 exits the flow diagram at 1105. If the selected ST does include a 16-byte data block, then control unit 370 compares the ST address with the LD address at 1106. At decision block 1107, control unit 370 determines whether the LD address is equal to the ST address plus four. If the LD address is not equal to the ST address plus four, then control unit 370 exits the flow diagram at 1108.

In decision blocks 1110-1112, control unit 370 determines whether the selected LD has a LD data request of one, two, or four bytes respectively. If the selected LD has a LD data request other than one, two, or four bytes, control unit 370 exits the flow diagram at 1113. Control unit 370 directs FSFB 310 to forward the ST data block from the selected ST to the rotator in process blocks 1114-1116. In process blocks 1117-1119, control unit 370 rotates one, two, and four bytes of Store data respectively so that the bytes of Store data are aligned with the LD address of the selected LD. Control unit 370 directs the rotator to forward the rotated data to RF 330 at 1120-1122. A LD does not always require all of the data within a ST data block. Any number of techniques can be used to truncate the data in a ST data block including only forwarding the requested data from FSFB 310 and only forwarding the requested data from rotator 320.

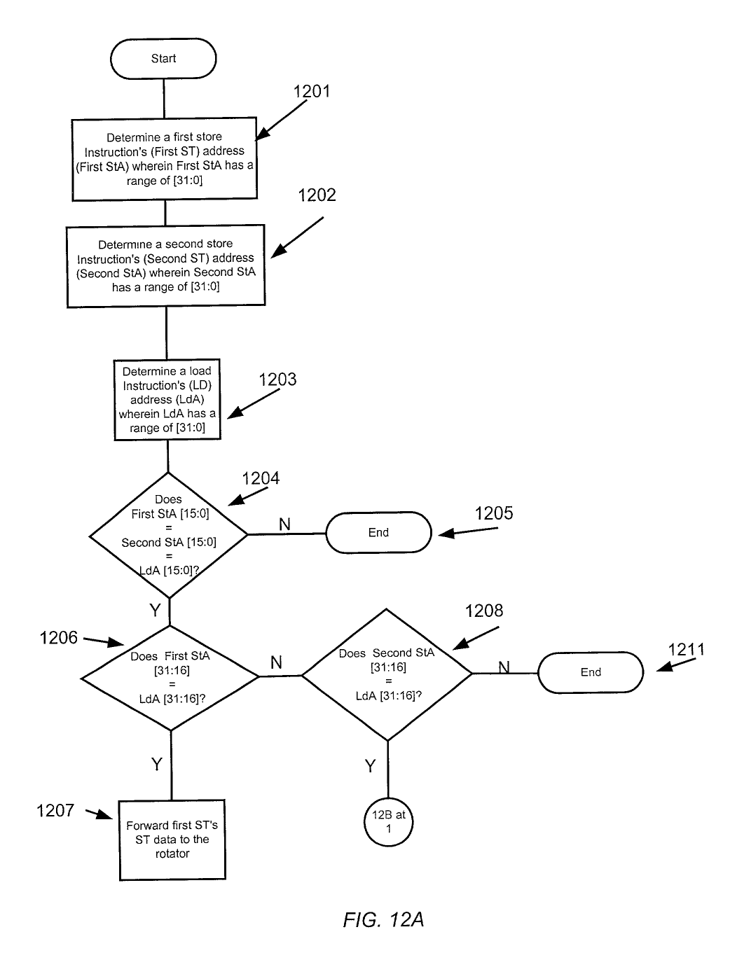

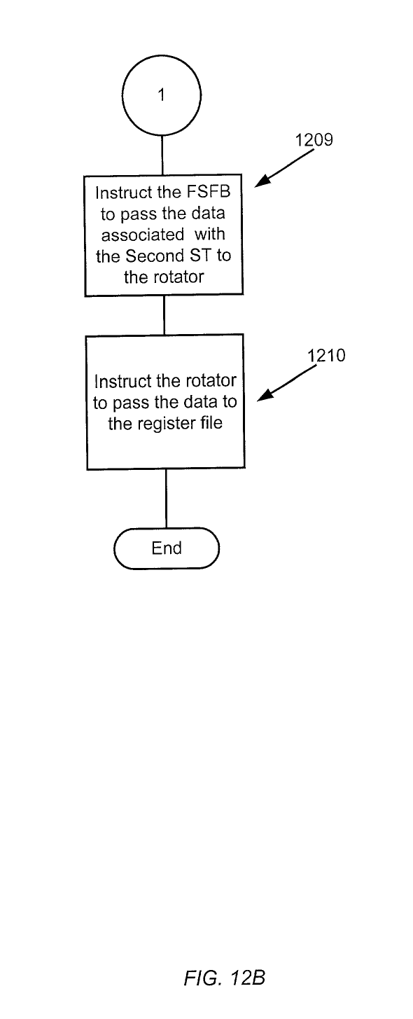

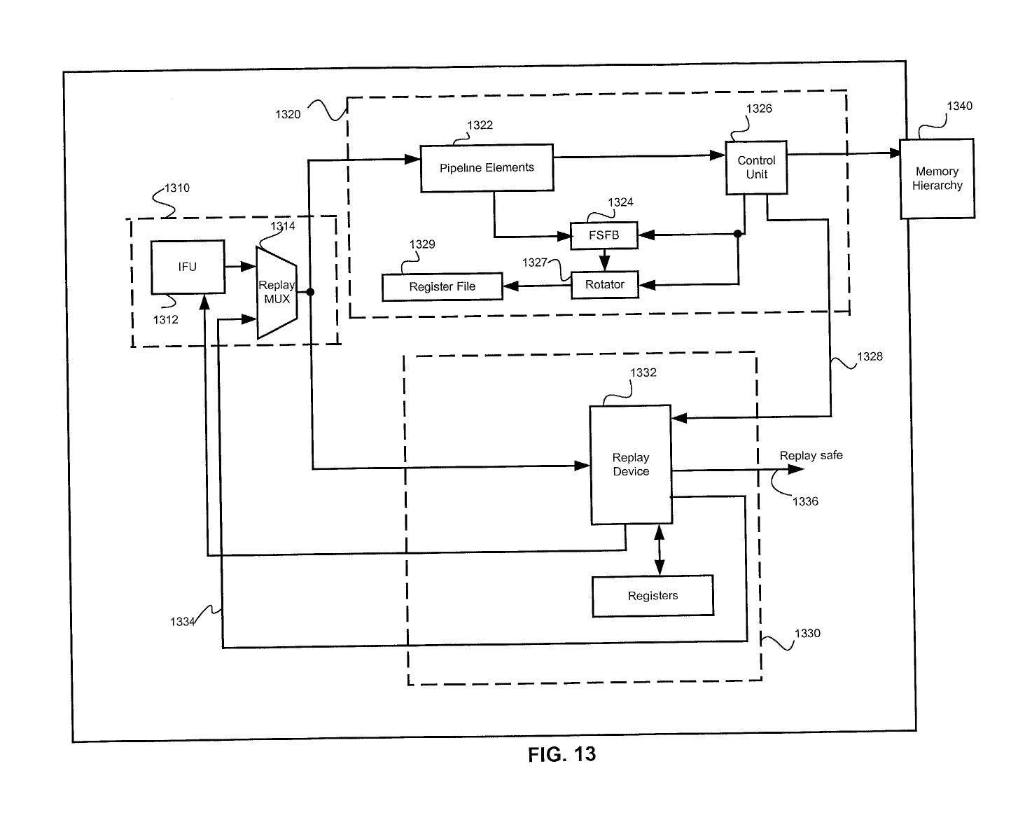

FIGS. 12A and 12B are flow diagrams illustrating another embodiment of the fast forwarding technique. In process block 1201, control unit 370 determines a first ST address of a selected first buffered ST. Similarly, in process block 1202, control unit 370 determines a second ST address of a selected second buffered ST. Control unit 370 determines a LD address of a selected buffered LD at 1203. At decision block 1204 control unit 370 determines whether a first portion of the first and a first portion of the second selected ST addresses are equal to the first portion of the selected LD address. Control unit 370 exits the flow diagram at 1205 if the selected address portions are not equal to each other.

At decision block 1206, control unit 370 determines whether a second address portion of the first selected ST matches a second address portion of the selected LD. If the second address portions do match, then control unit 370 directs FSFB 310 to forward the ST data block of the first selected ST to RF 330 through rotator 320 at 1207. Otherwise, control unit 370 determines whether a second address portion of the second selected ST matches a second address portion of the selected LD. If the second address portions do match, then control unit 370 directs FSFB 310 to forward the ST data block of the second selected ST to RF 330 through rotator 320 at 1209-1210. Otherwise control unit 370 exits the flow diagram at 1211. In one embodiment of the invention, the first address portion of a selected LD or a selected ST comprises bits [15:0] of a 32-bit address. Similarly, in an embodiment of the invention, the second address portion comprises bits [31:16] of a 32-bit address. A person of ordinary skill in the art will recognize, however, that the first and second address portions can be virtually any combination of bits of an address of virtually any length.

FIG. 13 illustrates another embodiment of portions of the processor shown in FIG. 1. FIG. 13 includes scheduler system 1310, load pipeline 1320, and replay system 1330. Scheduler system 1310 issues instructions for execution. Load pipeline 1320 receives issued LDs from scheduler system 1310 and executes the LDs in a pipelined manner. In some embodiments of the invention, replay system 1330 maintains a pipeline of instructions that parallels the instructions in load pipeline 1320.

According to an embodiment of the invention, load pipeline 1320 receives a LD from replay multiplexer 1314. Pipeline elements 1322 decode the LD and generate a LD address. FSFB 1324 buffers one or more store operations having one or more ST addresses. If a ST address matches the LD address, FSFB 1324 forwards the corresponding ST data without the need for input from control unit 1326. In an embodiment of the invention, if there is not a ST with a ST address that matches the LD address, FSFB 1324 does not forward ST data, unless control unit 1326 supplies additional information to FSFB 1324.

Control unit 1326, as described above, detects a number of dependencies between the LD and a buffered ST. Control unit 1326 receives the LD after the LD has passed through pipeline elements 1322. Control unit 1326 informs FSFB 1324 and rotator 1327 that a dependency exists but, because the LD has already passed through pipeline elements 1322, FSFB 1324 cannot satisfy the LD, in an embodiment of the invention.

Replay device 1332 is used to “replay” the LD after control unit 1326 detects a dependency, in an embodiment of the invention. Control unit 1326 instructs replay device 1332 to replay the LD through communication channel 1328. Replay device 1332 sends the LD to replay multiplexer 1314 through communication channel 1334. Replay device 1332 also instructs IFU 1312 to stop the instruction stream briefly so that the LD can be inserted into the instruction stream.

Replay multiplexer 1314 sends the LD to load pipeline 1320 for a second time. Pipeline elements 1322 generate the LD address and send the LD address to FSFB 1324, in an embodiment of the invention. FSFB 1324 employs the information supplied to it by control unit 1326 and forwards the ST data of the relevant ST to rotator 1327. Rotator 1327 rotates the ST data, as described above, and forwards the relevant portions of the ST data to register file 1329.

The ST data may include more data than the LD requires. Rotator 1327 forwards only those portions of the ST data that are required by the LD, in an embodiment of the invention. For example, the ST may have four bytes of ST data. The LD, however, may only require two bytes of data. Control unit 1326 directs FSFB 1324 and rotator 1327 to forward the two bytes of ST data that are required by the LD. Rotator 1327 only forwards the two required bytes of ST data to register file 1329, in an embodiment of the invention.

Control unit 1326 verifies that ST data was forwarded to satisfy the LD, when the LD reaches control unit 1326 during the second iteration. If a buffered ST does not contain the data required by the LD, memory hierarchy 1340 is accessed to obtain the data. Control unit 1326 informs replay device 1332 that the LD is satisfied through communication channel 1328. Replay device 1332 retires the LD through communication channel 1336.

In the above description, the LD was satisfied during the second iteration of executing the LD. Under some conditions, however, a LD must be replayed more than once so that control unit 1326 has adequate time to detect dependencies and inform FSFB 1324 and rotator 1327 of the detected dependencies. Replay system 1330, in some embodiments of the invention, continues to replay a LD until control unit 1326 signals that the LD has been satisfied.

The force forwarding technique described herein can be implemented as instructions which may be used to program a computer (or other electronic devices) to perform a process described herein. The electronically accessible medium may include, but is not limited to, floppy diskettes, optical disks, CD-ROMs, and magneto-optical disks, ROMs, RAMs, EPROMs, EEPRPOMs, magnet or optical cards, flash memory, or other type of media/electronically accessible medium suitable for storing electronic instructions. Moreover, the present invention may also be downloaded as a computer program product, wherein the program may transferred from a remote computer to a requesting computer by way of data signals embodied in a carrier wave or other propagation medium via a communications link (e.g., a modem a network connection).

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

[image]

What is claimed is:

1. An apparatus comprising:
a first buffer having one or more buffer slots to buffer memory store instructions (STs);
a second buffer having one or more buffer slots to buffer memory load instructions (LDs);
a control device coupled to the first buffer and the second buffer to conditionally signal the first buffer to output store data of a buffered ST to fill a buffered LD if the control device determines that the buffered ST contains data that is requested by the buffered LD; and
a rotator coupled to the first buffer and also coupled to the control device to receive store data and to rotate store data.

2. The apparatus of claim 1 wherein store data is organized into bytes of store data and the rotator is to rotate store data on a byte by byte basis.

3. The apparatus of claim 1 wherein the control device determines whether a LD address of the buffered LD is N address locations greater than an address of a buffered ST.

4. The apparatus of claim 3 wherein the control device sends a signal over a conductor to the first buffer instructing the first buffer to forward store data of the buffered ST and to send a signal over the conductor to the rotator to direct the rotator to rotate the store data by a number N.

5. The apparatus of claim 1 wherein the control device further comprises one or more comparators to compare a LD address with one or more ST addresses wherein the LD address and the one or more ST addresses include a first address portion and a second address portion and the one or more comparators compare the first address portion of the LD address with the first address portions of the one or more ST addresses and also compare the second address portion of the LD address with the second address portions of the one or more ST addresses.

6. The apparatus of claim 5 wherein the control device identifies one or more buffered STs having a first address portion that matches a first address portion of the buffered LD and also having a second address portion that matches the second address portion of the buffered LD.

7. The apparatus of claim 1 wherein the control device identifies one or more buffered STs having a first address portion equivalent to a first address portion of the buffered LD and having a second address portion not equivalent to a second address portion of the buffered LD.

8. A method comprising:
buffering one or more memory store instructions (STs) in a first buffer;
buffering one or more memory load instructions (LDs) in a second buffer;
determining whether a buffered LD is dependent on a buffered ST wherein the buffered LD is dependent on the buffered ST if the buffered LD requests data that is contained in the buffered ST; and
signaling the first buffer to forward data from the buffered ST to a rotator if the buffered ST contains ST data that is requested by the buffered LD.

9. The method of claim 8 further comprising rotating forwarded store data from a first position to a second position.

10. The method of claim 8 wherein determining whether a buffered LD is dependent on a buffered ST further comprises:
comparing a first address portion of the buffered LD with a first address portion of one or more buffered STs; and
comparing a second address portion of the buffered LD with a second address portion of one or more buffered STs.

11. The method of claim 10 wherein determining if a buffered LD is dependent on a buffered ST comprises:
identifying a buffered ST having a first address portion equivalent to the first address portion of the buffered LD; and
having a second address portion not equivalent to the second address portion of the buffered LD.

12. The method of claim 8 wherein determining if a buffered LD is dependent on a buffered ST further comprises identifying a buffered LD having a LD address and a buffered ST having a ST address wherein the LD address is equivalent to the ST address plus a number N.

13. The method of claim 8 wherein determining if a buffered LD is dependent on a buffered ST further comprises identifying a buffered LD having a LD address and a buffered ST having a ST address wherein the LD address is equal to the ST address plus four and the buffered ST contains 16 bytes of store data.

14. The method of claim 8 wherein determining if a buffered LD is dependent on a buffered ST further comprises identifying one or more buffered STs having a first address portion that is equivalent to a first address portion of the buffered LD and a second address portion that is not equivalent to a second address portion of the buffered LD.

15. The method of claim 8 wherein determining if a buffered LD is dependent on a buffered ST further comprises identifying a buffered ST having a first address portion that is equivalent to a first address portion of the buffered LD and having a second address portion that is equivalent to a second address portion of the buffered LD.

16. An article comprising a machine readable medium storing information representing a processor, the processor comprising:
a store buffer to buffer store data;
logic to forward store data coupled to the store buffer;
a load buffer to buffer load operations coupled to the logic to forward store data; and
a rotator coupled to the store buffer and the logic to forward store data to reorder store data.

17. The article of claim 16 wherein the logic to forward store data is to detect a buffered store having a store address that is one, two, or three address locations less than an address of a buffered load operation.

18. The article of claim 17 wherein the logic to forward store data is
to signal the store buffer to forward store data of the buffered store having the store address that is one, two, or three address locations less than the address of the buffered load operation to the rotator; and
to signal the rotator to reorder the store data.

19. The article of claim 16 wherein the logic to forward store data is to detect a buffered store having a store address that is four address locations less than an address of a buffered load operation.

20. The article of claim 19 wherein the logic to forward store data is
to signal the store buffer to forward store data of the buffered store having the store address that is four address locations less than the address of the buffered load operation to the rotator; and
to signal the rotator to reorder the store data.

21. An apparatus comprising:
a store buffer to buffer store data;
logic to forward store data coupled to the store buffer;
a load buffer to buffer load operations coupled to the logic to forward store data; and
a rotator coupled to the store buffer and the logic to forward store data to reorder store data.

22. The apparatus of claim 21 wherein the logic to forward store data is to detect a buffered store having a store address that is one, two, or three address locations less than an address of a buffered load operation.

23. The apparatus of claim 21 wherein the logic to forward store data is to detect a buffered store having a store address that is four address locations less than an address of a buffered load operation.

24. The apparatus of claim 21 further comprising:
one or more buffered store operations having one or more store addresses, the one or more store addresses having a lower portion and an upper portion;
a buffered load operation having a load address, the load address having a lower portion and an upper portion; and
wherein the logic to forward store data is to detect a buffered store having a lower address portion matching the lower portion of the load address and an upper address portion not matching the upper portion of the load address.

25. The apparatus of claim 24 wherein the logic to forward store data is to signal the store buffer to not forward store data from the buffered store having a lower address portion matching the lower portion of the load address and an upper address portion not matching the upper portion of the load address.

26. The apparatus of claim 25 wherein the logic to forward store data is to detect another buffered store having a lower address portion matching the lower portion of the load address and an upper address portion matching the upper portion of the load address.

27. The apparatus of claim 26 wherein the logic to forward store data is to signal the store buffer to forward store data from the buffered store having a lower address portion matching the lower portion of the load address and an upper address portion matching the upper portion of the load address.

28. The apparatus of claim 22 wherein the logic to forward store data is to signal the store buffer to forward store data of the buffered store having the store address that is one, two, or three address locations less than the address of the buffered load operation to the rotator.

29. The apparatus of claim 28 wherein the store data is organized into bytes of store data and the logic to forward store data is to signal the rotator to rotate the bytes of store data by one, two, or three bytes.

30. The apparatus of claim 29 wherein the logic to forward store data is to signal the rotator to forward the rotated store data to a register file.

31. An apparatus comprising:
a store buffer to buffer store data;
a load buffer to buffer load operations;
logic to forward store data to forward data for a buffered store having a store address that partially matches an address of a buffered load operation; and
a buffered store having a store address that partially matches an address of a buffered load operation.

32. The apparatus of claim 31 wherein said logic to forward is to forward data for a buffered store having a store address that is one, two, or three address locations less than an address of a buffered load operation.

33. The apparatus of claim 32 further comprising a rotator.

34. The apparatus of claim 33 wherein the buffered store has four bytes of store data.

35. the apparatus of claim 34 wherein the logic to forward store data forwards less than four bytes of store data.

36. The apparatus of claim 31 wherein said logic to forward is to forward data for a buffered store having a store address that is four address locations less than an address of a buffered load operation.

37. The apparatus of claim 36 further comprising a rotator.

38. The apparatus of claim 37 wherein the buffered store has 16 bytes of store data.

39. The apparatus of claim 38 wherein the logic to forward store data forwards less than 16 bytes of store data.

40. The apparatus of claim 31 further comprising a rotator.
